(19) United States
(12) Patent Application Publication
(10) Pub. No.: US 2005/0276158 A1
(43) Pub. Date: Dec. 15, 2005

(54) Systems and devices for industrial mixing applications

(76) Inventor: Scott Thomas, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/854,626

(22) Filed: May 26, 2004

(51) Int. Cl. B01F 7/00

(52) U.S. Cl. 366/250; 366/251

(57) ABSTRACT

Systems and devices for industrial, and other, mixing applications are disclosed. The mixer includes a mixing assembly that is attached to a power head which operates the mixing assembly. A housing of the power head encloses a motor that has an input power connection arranged so that power supplied to the power head causes rotation of an output element that, in turn, is attached to the input of an interchangeable reduction gear train. The reduction gear train also includes an output which is coupled to a transfer element configured to slidingly receive a portion of a mixing shaft. An interchangeable impeller attached to one end of the mixing shaft serves to perform the mixing function. Finally, a shaft lock is provided that cooperates with the transfer element to facilitate positioning and locking of the mixing shaft in a variety of different operating positions.

### RELATED APPLICATIONS

Not applicable.

### BACKGROUND OF THE INVENTION

1. Field of the Invention

The present invention relates generally systems and devices for industrial mixing applications. More particularly, exemplary embodiments of the invention are concerned with a mixer having various chemically inert components and constructed so as to be readily reconfigured to suit a variety of different operating environments.

2. Related Technology

The wide variety of mixing systems and devices reflects the virtually endless number of mixing applications and associated process materials. For example, some mixing systems and devices are required to operate in high temperature applications, while other mixing systems and devices are designed for use in cryogenic applications. Yet other mixing devices and systems find application in connection with highly corrosive, combustible, or otherwise unstable and/or dangerous materials. In still other applications, mixers and related systems and devices are often employed in environments where maintenance of the purity and integrity of the material or materials to be mixed, as well as the particular manner of mixing, is of great importance.

More particularly, the manner in which certain materials are mixed is often a function of the particular type of process material or materials involved. By way of example, certain slurries, such as may be employed in semiconductor and related manufacturing processes, commonly known as chemical mechanical planarization (CMP), may very greatly from one type to the next with regard to properties such as their sensitivity to shear forces imposed on the slurry as a result of the mixing process.

As one example, oxide CMP slurries are relatively shear sensitive and, accordingly, require relatively slow mixing speeds and reduced shear forces so that a good mix can be obtained without impairing the homogeneity or other properties of the mixture. In contrast, metal CMP slurries are not as shear sensitive and typically require a relatively faster mixing speed so that the high concentration of solids in the slurry will remain suspended and not settle out of solution. The aforementioned situation concerning the variance and relative sensitivity of particular materials to shear forces imposed by mixing processes is particularly problematic because typical mixing systems and devices are not well suited to be readily adapted to conform with differing mixing requirements and situations.

For example, processing plant operators are typically required to purchase a number of different specialized mixers, each of which is suited primarily for a single specific application or a relatively narrow group of related mixing applications. This approach to the situation is problematic because it can impose significant costs on the operator by requiring the operator to purchase multiple mixers. Correspondingly, the use of several different mixers necessarily increases the maintenance burden and the costs associated with maintaining the various different types of mixers.

A related concern is that typical mixers and mixing devices, while designed to operate at a particular nominal revolutions per minute (“RPM”), actually tend to operate over a range of operating speeds. In some cases, the variation in operational speed associated with a mixing device can significantly compromise the integrity and other properties of the material and materials being mixed. This is due at least in part to the fact that typical mixers lack speed monitoring and/or speed control mechanisms. Thus, the operator must simply assume that the mixer is operating at the nominal RPM for which the mixer is designed, and any out-of-range operation is neither detected nor readily corrected. A related concern is that the properties of the input power to such mixers can vary, thereby causing undesirable, and undetected, fluctuations in operating speed. For example, variations in the electrical current and/or input voltage to a mixing device may cause the mixing device to operate at out-of-range speeds

Yet other concerns with known mixing systems and devices relate to the materials used in the construction of such systems and devices. By way of example, mixers such as are sometimes employed in semiconductor manufacturing and processing typically involve the use of a stainless steel or other metallic mixing shaft for mixing slurries that are used to polish semiconductor wafers. In addition to other problems that they present, such metallic shafts are cause for concern in that the coating that is typically employed on such shafts tends to be shed by the shaft over a period of time, thereby contaminating the slurry that is used to polish the wafers.

In addition, metallic shafts are relatively heavy and, accordingly, necessitate the use of relatively larger drive motors and power supplies. Further, the additional weight of such mixing shafts makes them somewhat more difficult for the operator to handle.

Another disadvantage of the mixing shafts typically employed in connection with typical mixing devices is that such shafts typically come with a pre-determined length that cannot be adjusted. This is particularly problematic where the mixers are intended to be used with barrels or other containers of varying size and depth. As with other aspects of typical mixers, this characteristic significantly impairs the flexibility and functionality of the mixer.

Yet other concerns with known mixing devices relate particularly to mixing devices intended for use with various types of barrels and drums. In particular, typical mixing devices and systems are not well suited for ready attachment to, and detachment from, such barrels and drums. Moreover, while it is often useful for an an operator to be able to insert the mixing shaft into the barrel or drum at a particular angle, typical mixers and devices and related components are not adapted to enable such advantageous positioning of the mixing shaft.

In view of the foregoing, and other, problems in the art, it would be useful to provide mixing systems and devices that include substantially chemically inert mixing components that are constructed so as to be readily reconfigured to suit a variety of different operating environments and requirements.

### BRIEF SUMMARY OF AN EXEMPLARY EMBODIMENT OF THE INVENTION

In general, embodiments of the invention are concerned with systems and devices for industrial mixing applications. At least one exemplary embodiment is directed to a mixer having various chemically inert components and constructed so as to be readily reconfigured and adapted to suit a variety of different operating environments.

The exemplary implementation of the mixer includes a mixing assembly that is removably attached to a power head which operates the mixing assembly. The power head includes a housing enclosing a motor that has an input power connection, such as to receive a supply of DC current or compressed air, for example. The input power connection is arranged so that the power supplied to the power head causes rotation of an output element, such as a motor shaft for example, that is attached to the input of an interchangeable reduction gear train. The reduction gear train also includes an output which is coupled to a transfer element configured to attach to a portion of a mixing shaft of the mixing assembly.

In addition, one or more shaft locks are provided that cooperate with the transfer element to facilitate positioning, repositioning, and locking, of the mixing shaft in a plurality of operating positions. The mixing shaft is substantially non-metallic and includes an interchangeable impeller at one end that serves to perform the mixing function. The other end of the mixing shaft is slidingly received in the transfer element.

In operation, the relative length of the mixing shaft is adjusted as desired through the operation of the shaft locks. Once the desired length is achieved, the shaft is locked into position relative to the power head. Power is then supplied to the power head and, through the action of the reduction gear train and transfer element, applied to the mixing shaft. The resulting rotation of the mixing shaft causes a corresponding motion of the impeller, thereby mixing the fluid(s) or other materials in which the impeller is immersed.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a perspective view illustrating various aspects of an exemplary mixer that includes a power head and mixing assembly;

FIG. 2 is an exploded perspective view illustrating various aspects of an exemplary power head;

FIG. 2A is a detail view showing aspects of an exemplary reduction gear train and the relation of the reduction gear train to an embodiment of a transfer element that is configured to interface with a mixing shaft;

FIG. 2B is a detail perspective view of a portion of an exemplary air-operated power head, illustrating the arrangement and position of an air flow control valve;

FIG. 2C is a perspective view providing further details concerning the air flow control valve indicated in FIG. 2B;

FIG. 3A is a schematic diagram illustrating aspects of an exemplary closed-loop speed monitoring and control system;

FIG. 3B is a schematic diagram illustrating aspects of an exemplary open-loop speed monitoring and control system;

FIG. 3C is a schematic diagram illustrating aspects of an exemplary speed monitoring system;

FIG. 4 is a perspective view of an exemplary implementation of a mixing assembly that includes a mixing shaft and associated impeller;

FIG. 4A is a section view of an exemplary alternative terminal portion of a mixing shaft/impeller;

FIG. 5 is a perspective view of an exemplary transfer element suited for interconnecting the mixing shaft with the power head;

FIG. 6 is a detail view of an exemplary barrel adapter configured to allow positioning of the mixing shaft at a predetermined angle;

FIG. 7 is a perspective view showing an exemplary barrel adapter as installed on a barrel; and

FIG. 8 is a rear view showing an exemplary arrangement of a power head interlocked with a barrel adapter that is attached to a barrel.

### DETAILED DESCRIPTION OF EXEMPLARY EMBODIMENTS OF THE INVENTION

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

Generally, embodiments of the invention concern systems and devices for use in connection with various types of industrial mixing processes. At least some embodiments of the invention are particularly well suited for use in applications where maintenance of the purity of the process material is especially important. One example of such an application is the mixing of slurries such as are used in semiconductor wafer polishing processes.

However, the scope of the invention is not limited to any particular application. Rather, embodiments of the invention may be employed in any situation or environment where the functionality and characteristics disclosed herein may prove useful or desirable. Examples of other applications for embodiments of the invention include, but are not limited to, chemical applications, cosmetics, pharmaceuticals, biotech industry, life sciences, and semiconductor manufacturing processes.

I. General Aspects of an Exemplary Mixer

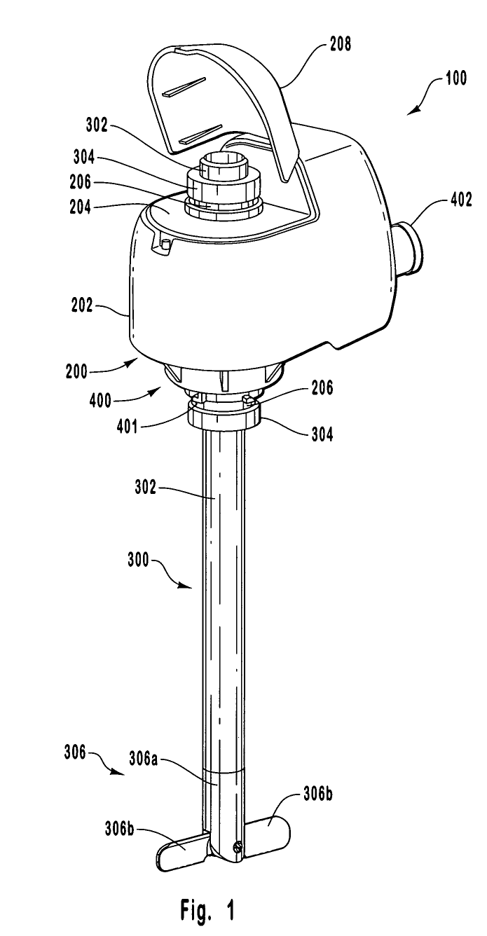

Directing attention now to FIG. 1, details are provided concerning an exemplary embodiment of a mixer, denoted generally at 100. It should be noted that the discussion of FIG. 1 is primarily a general description of various aspects of an exemplary mixer 100, and more particular details are provided elsewhere herein concerning the various particular components included in the exemplary mixer 100.

The illustrated embodiment of the mixer 100 includes a power head 200 to which a mixing assembly 300 is attached. With attention first to the power head 200, a housing 202 is provided that substantially encloses a motor 400 and an associated reduction gear train (not shown), as discussed in further detail below. The housing 202 may be constructed from a variety of materials including plastics, metals, or composite materials and is configured to accommodate an input power connection 402 for the motor 400.

In addition, the housing 202 defines an upper opening 204 configured to receive a transfer element 206 that serves as an interface between the motor 400 and a shaft of the mixing assembly 300. While further details concerning this arrangement are provided below, the transfer element 206, as shown in FIG. 1, is generally configured and arranged to receive the mixing shaft 302 of the mixing assembly 300. In this regard, the housing 202 includes a cover 208 which may assume a raised position, a partially lowered position, or a closed position, depending upon the extent to which the mixing shaft 302 extends upward through the transfer element 206.

In at least some instances, it is desirable to configure and position the mixing shaft 302 so that the cover 208 can be completely closed. In this way, foreign material can be prevented from contaminating the mixing shaft 302 and/or the motor 400.

With continuing attention to FIG. 1, the motor 400 is attached to the housing 202 by way a plurality of fasteners 210, such as screws for example. Additionally, the exemplary motor 400 is configured for a bayonet-type attachment to a barrel adapter, discussed below, and to that end, the motor 400 includes one or more projections 401A and locking pins 401B.

As noted earlier, a transfer element 206, embodied in FIG. 1 as a sleeve that is threaded at either end, is provided that interfaces with the motor 400 so that the action of the motor 400 imparts a rotation to the mixing shaft 302 passing through the transfer element 206. As discussed in further detail below, a pair of shaft locks 304, embodied in some instances as a pair of compression nuts, are positioned to be tightened on the threaded portions of the transfer element 206 and thereby secure the mixing shaft 302 in a desired position relative to the power head 200.

The mixing assembly 300 further includes an impeller 306 attached to one end of the mixing shaft 302 and including a body 306A to which two or more mixing elements 306B are attached. In the illustrated embodiment, the mixing elements 306B generally are rotatably attached to the body 306A and take the form of blades having a partial circular cross section, but other mixing element arrangements and configurations may be employed as well.

In operation, power supplied to the motor 400 by way of the input power connection 402 causes the motor, and thus, the received transfer element 206 to rotate. Because the mixing shaft 302 is securely positioned within the transfer element 206 by way of the shaft locks 304, the shaft 302 rotates correspondingly. As the shaft 302 rotates, the mixing elements 306B move, under the influence of the resulting centripetal force, into a position, such as that shown in FIG. 1 for example, where the mixing elements 306B are able to mix the fluid within which the impeller 306 is immersed.

II. Aspects of an Exemplary Motor and Gearing System

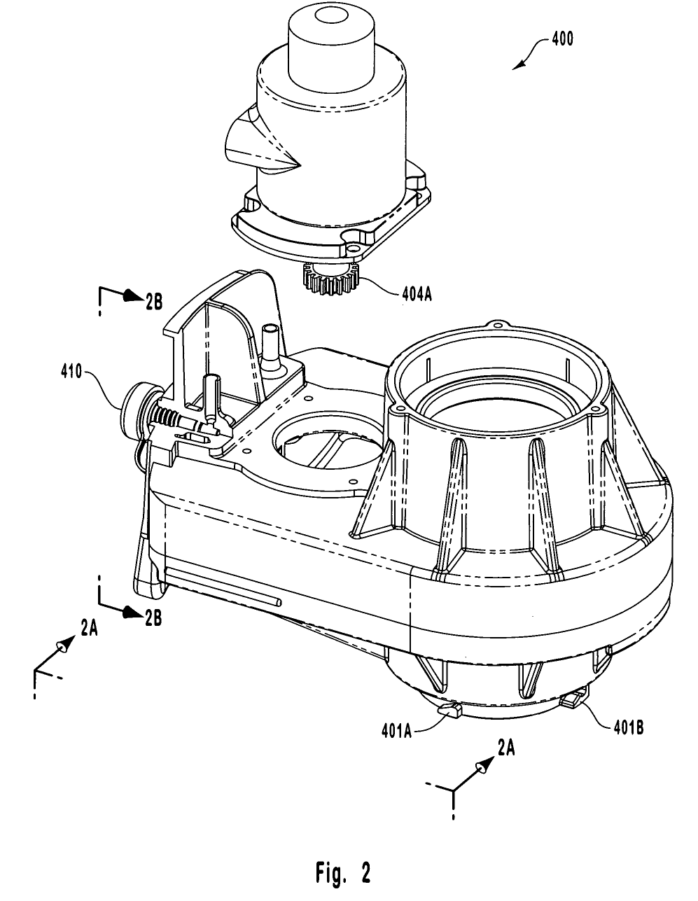

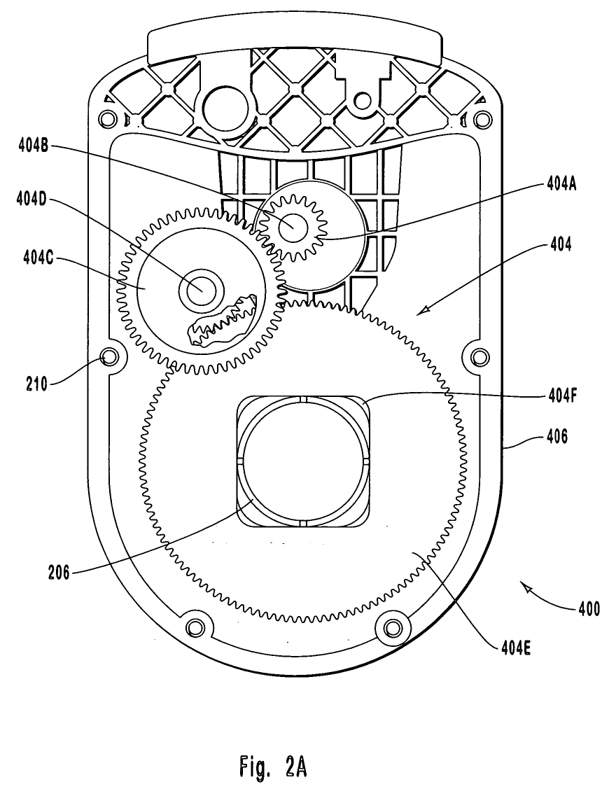

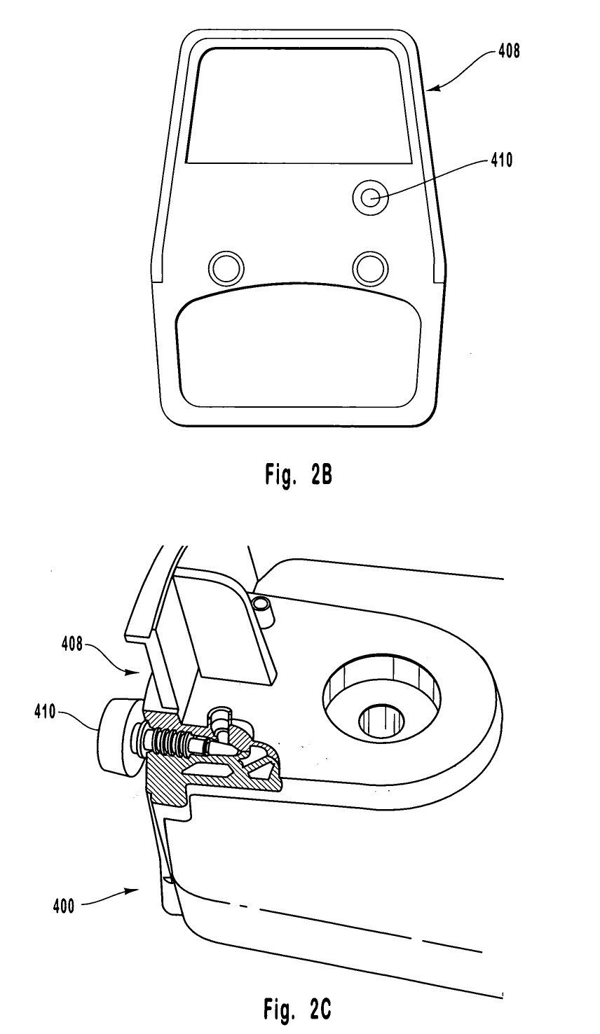

Directing attention now to FIG. 2, further details are provided concerning an exemplary embodiment of the motor 400. In at least some embodiments of the invention, the motor 400 comprises an air powered motor which uses a supply of compressed air to cause rotation of the motor. In yet other embodiments, the motor 400 may be configured for use with a DC current source, or any other suitable power source. Motors configured for use with various other types of input power sources may be employed as well. Accordingly, the scope of the invention should not be construed to be limited to any particular type of motor.

The power received through the input power connection 402, discussed above, is applied to a gear train 404 that resides substantially within a motor housing 406. Because embodiments of the invention contemplate both reduction arrangements, and non-reduction arrangements, as discussed below, the gear arrangement is generally referred to herein simply as a “gear train.”

Consistently, the scope of the invention is not constrained or limited to the use of reduction gears. Rather, it may be desirable in some cases to use gear arrangements that do not require the use of reduction gears or further still, other drive arrangements that do not employ any gears. Accordingly, embodiments of the invention assume a wide variety of different configurations and are not limited to the exemplary embodiments disclosed herein.

In the illustrated embodiment, the gear train 404 includes an input gear 404A, which may also be referred to herein simply as an “input” of the gear train 404, disposed on an input shaft 404B that is coupled, directly or indirectly, with the power source. The input 404A, in turn, is coupled with an intermediate gear 404C mounted to an intermediate shaft 404D. An output gear 404E, or simply “output” of the gear train 404, is positioned and arranged to be driven by the intermediate gear 404C.

Because the transfer element 206 is positioned and arranged for motion in consonance with motion of the output gear 404E, as indicated in FIG. 2, this interaction between the gears, and the motion imparted to the gear train 404 by way of the power supply, causes the rotation of the transfer element 206 and, thus, the mixing shaft 302 (see FIG. 1) positioned therein. More particularly, the exemplary output gear 404E includes or defines a rectangular, square, or other polygonal opening 404F having relatively straight sides configured for contact with flats defined on the transfer element 206 so that no relative rotation occurs between the transfer element 206 and the output gear 404E.

Due to the configuration and arrangement of the gearing in the gear train 404, the rotational speed of the output gear 404E in RPM, is substantially slower than the rotational speed of the input gear 404A. This type of arrangement is particularly useful where the motor 404 comprises an air-powered motor. In particular, air-powered motors are often most effective and efficient with a relatively high speed input gear. However, such high input speeds are often not conducive to effective mixing. Accordingly, the intermediate gear 404C and output gear 404E act to reduce the speed of the mixing shaft so as to achieve a desired mixing effect, while also allowing a relatively high input speed such as contributes to improved motor performance.

As suggested by the foregoing, various aspects of the gear train 404 may be varied or selected as necessary to suit the requirements of a particular application. For example, in at least some embodiments of the invention, the gear train 404 is interchangeable with other reduction gear sets. In this way, the actual mixing speed of the mixer 100 can be readily changed to accommodate different requirements and mixing situations.

By way of example, a reduction gear ratio of 4:1 may be desirable in some instances, while a ratio of 11½:1 may be useful in other cases. It should be noted that the scope of the invention is not so limited however. For example, gear ratios falling within the range of about 1:1 to about 15:1 are useful in some applications. Further, the gear ratio need not be a reduction ratio in every case. In particular, the gear ratio is simply 1:1 in some embodiments.

More generally however, any desired gear ratio may be implemented through the selection of appropriate gears and gearing arrangements of the gear train 404. For example, reduction gear ratios typically vary according to variables such as, but not limited to, the shear sensitivity of the particular materials that are being mixed. Thus, highly shear sensitive materials such as oxide slurries require slow mixing, or output, speeds, while metal slurries can accommodate relatively higher mixing, or output, speeds. Along the same lines, the types and number of gears employed in a reduction gear train may be varied as well, as may be required to suit a particular application.

Because the gear train 404 is interchangeable with at least some embodiments, the power head 200 can be quickly and easily modified to accommodate a variety of different mixing situations. As noted earlier, the illustrated gear train 404 is but one exemplary embodiment of a reduction gear train and, accordingly, the scope of the invention should not be construed to be limited to the illustrated embodiment. By way of example, yet other implementations of the invention include planetary, or epicyclic, gear trains. In general however, any gear and/or gear train effective in implementing the functionality disclosed herein may be employed.

With regard to construction materials, the illustrated gear train 404 includes gears made of a strong, yet lightweight material, such as plastic for example. The scope of the invention is not so limited however, and various other suitable materials may alternatively be employed.

With continuing attention to FIG. 2A, and directing attention now to FIGS. 2B and 2C, further details are provided concerning an exemplary motor 400. In particular, FIG. 2B indicates a control and interface panel 408 that includes various controls and other devices for controlling and/or monitoring aspects of the operation of the motor 400. In the exemplary illustrated embodiment, the control and interface panel 408 includes a rotatable needle valve 410 that enables infinite adjustments to the air flow supplied to motor 400 and, more particularly, to the gear train 404. Because the mixing speed of the motor 400 is a function of the supplied air flow, the mixing speed of the mixer 100 can be readily and finely adjusted by appropriate rotation of the needle valve 410. In this regard, at least some embodiments of the invention provide for mixing shaft speeding monitoring and/or speed control.

III. Speed Monitoring and Control

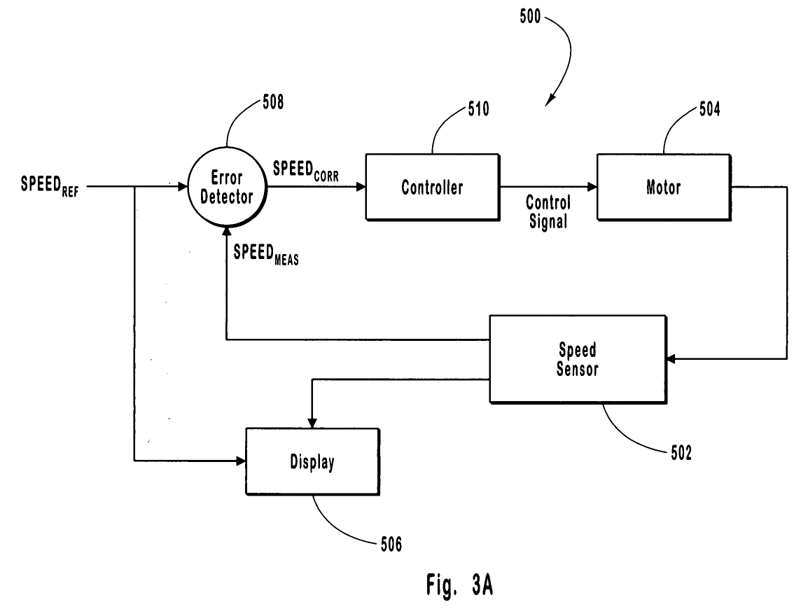

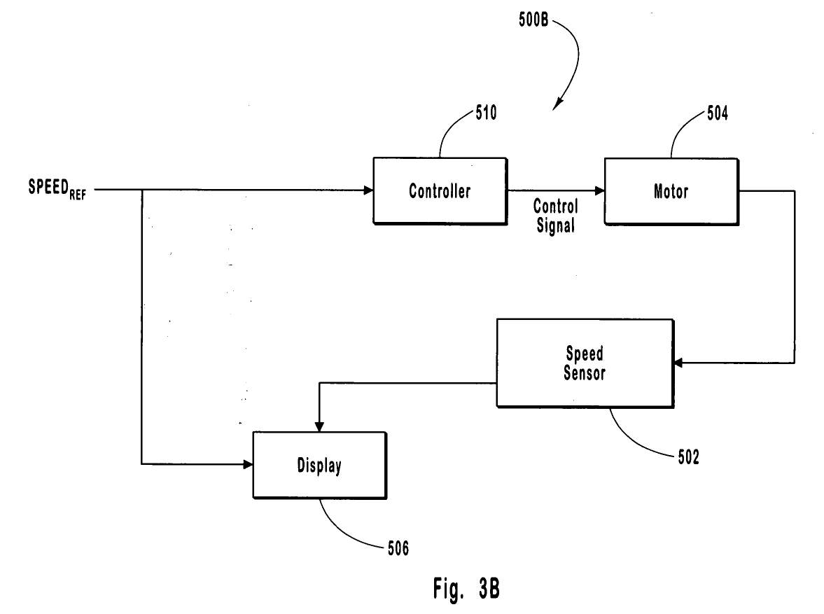

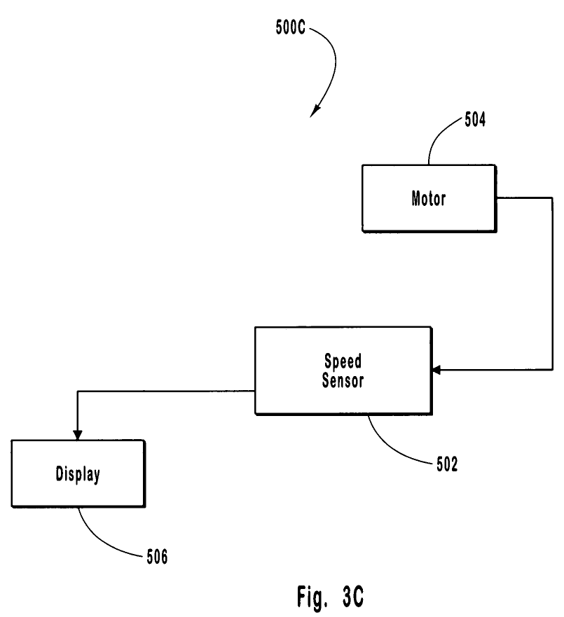

Directing attention now to FIGS. 3A through 3C, details are provided concerning exemplary speed monitoring and control systems such as may be employed in connection with the mixer 100. In the embodiment illustrated in FIG. 3A, the speed monitoring and control system is denoted generally at 500A and includes a speed sensor 502 configured and arranged to detect the speed of motor 504. In some cases, the speed sensor 502 includes a pickup, transducer or other element that interfaces with a magnet on a rotating element of the mixing assembly, such as the transfer element, so that RPMs can be measured and displayed.

In at least some implementations, a display 506 is provided that provides a digital or analog readout of the motor speed, in RPM for example, detected by the speed sensor 502. In addition, the speed monitoring and control system 500A includes an error detector 508 which is configured to receive a measured speed signal SPEED_{MEAS} from the speed sensor 502 and then communicate, if necessary, a corrected speed signal SPEED_{CORR} to a controller 510 which then generates and transmits an appropriate control signal to the motor 504.

More particularly, the error detector 508 receives a measured speed signal SPEED_{MEAS} from the speed sensor 502 and compares the received measured speed signal SPEED_{MEAS} with a reference speed signal SPEED_{REF} and then, if necessary, generates a corrected speed signal SPEED_{CORR} based on the result of the comparison between the measured speed signal SPEED_{MEAS} and the reference speed signal SPEED_{REF}.

In at least some implementations, the reference speed is also provided to the display 506 so that an operator can readily discern the difference between the reference speed and the actual speed at any given time. This functionality may prove useful, for example, where a malfunction has occurred and the motor 504 is not operating at the proper speed. In at least some embodiments, the display 506 is located on or near the power head 200.

While the illustrated embodiment of the speed monitoring and control system 500A generally depicts a closed loop configuration, various other configurations may alternatively be employed. For example, other implementations of a speed monitoring and control system provided for open loop control of the motor speed. Directing attention now to FIG. 3B, details are provided concerning an exemplary implementation of an open loop speed monitoring and control system 500B. In the exemplary open loop control system illustrated in FIG. 3B, no error detector is provided. Rather, the reference speed signal SPEED_{REF} is input directly to the controller 510. The controller 510 then transmits a corresponding control signal to the motor 504, causing the motor to rotate at the desired speed. The speed of the motor 504 is detected by the speed sensor 502 and transmitted to the display 506 where the motor speed information is visually displayed. In the illustrated implementation, the reference speed is likewise presented on the display so that an operator can determine if there is a difference between the desired, or reference, speed of the motor, and the actual speed of the motor as detected by the speed sensor 502.

At least some implementations of the open loop speed monitoring and control system 500B additionally, or alternatively, include high and/or low speed alarms or comparable indicators, which may be visual and/or audible to a user, that provide an indication that the motor 502 is not operating at the desired speed. For example, one such alarm is configured to be triggered when the differential between the reference speed and the speed detected by the sensor 502 reaches a predetermined point. This alarm can be configured to trigger with respect to a defined differential above the desired operating speed and/or below the desired operating speed.

While speed control is useful in certain applications, it may be the case that speed control is not necessary or desired in other applications. Rather, an operator or other personnel simply need to know the operating speed of the motor. In such cases, a speed monitoring system is provided that simply monitors and displays the speed of the motor. One example of such a speed monitoring system comprises a speed sensor connected with the motor and configured to transmit a signal to the display so that the detected speed of the motor can be displayed.

Directing attention now to FIG. 3C, further details are provided concerning an implementation of a speed monitoring system 500C. The speed monitoring system 500B is similar to the speed control systems 500A and 500B in that the elements of the speed monitoring system 500C include the speed sensor 502, motor 504, and display 506. However, the speed monitoring system 500C does not implement control functionality and, instead, simply provides information to an operator or other personnel as to the speed of the motor.

In operation, the speed sensor 502 detects the speed of a rotating element of the motor 504, or other element attached to a rotating element of the motor 504. The information obtained by the speed sensor 502 is then transmitted to the display 506 where the speed of the motor 504, expressed in RPM for example, is visually displayed. Some implementations of the speed monitoring system 500C include high and/or low speed alarms or comparable indicators, which may be visual and/or audible to a user, that provide an indication that the motor 502 is not operating at the desired speed.

IV. Aspects of an Exemplary Mixing Assembly

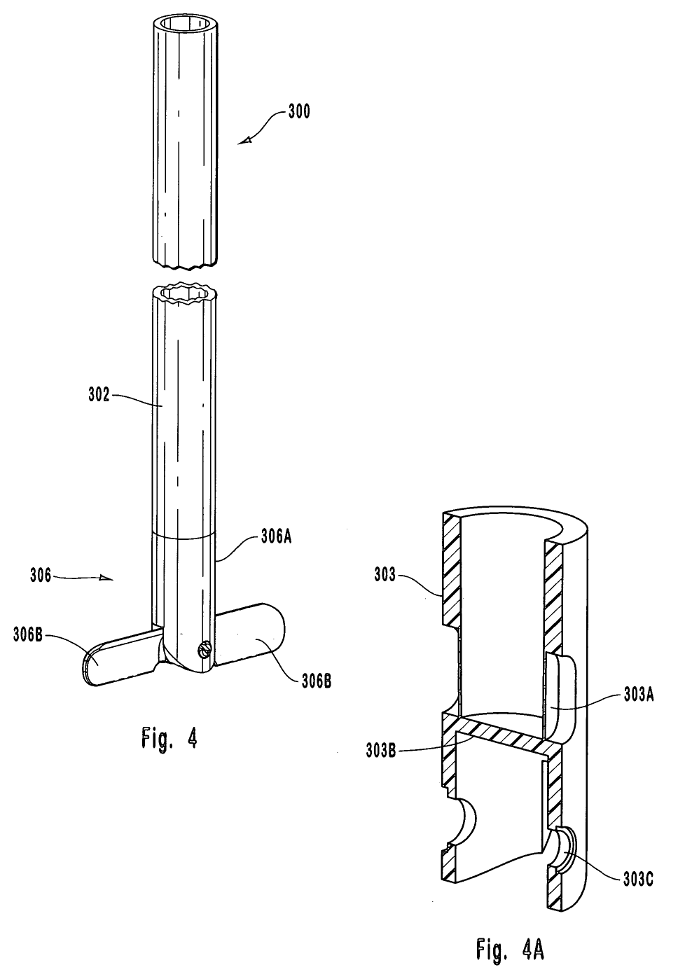

Directing attention now to FIG. 4, further details are provided concerning an exemplary implementation of the mixing assembly 300 generally discussed above in connection with FIG. 1. As noted earlier, the exemplary mixing assembly 300 generally includes a mixing shaft 302 to which is attached an impeller 306 that includes a body 306A having a pair of mixing elements 306B attached thereto.

In at least some embodiments of the invention, the mixing shaft 302, as well as the impeller 306, comprise a substantially non-metallic material, such as plastic or nylon. In one particular implementation, the mixing shaft 302 and impeller 306 are both substantially composed of material such as perfluoroalkoxy fluorocarbon (“PFA”), polypropylene, polyethylene, or other materials of comparable characteristics. In some alternative implementations, the mixing elements 306B and/or other components may be substantially composed of polytetraflouroethylene (“PTFE”). Of course, any other suitable materials may be employed. One useful aspect of such chemically inert materials as those noted above is that they do not chemically interact with the materials being mixed, so that the operator of the mixer 100 can be assured that the integrity of the mixed solution is not impaired or compromised as a result of the composition of the mixing assembly 300.

In at least some implementations of the invention, the mixing shaft 302 is substantially hollow. Among other things, this configuration enables the use of relatively lightweight mixing shaft 302, thereby reducing the load on the motor 400 and, thus, the size of motor 400 needed. In addition, a hollow mixing shaft 302 may be used to pump materials out of a barrel containing material that has been mixed or is to be mixed.

Aspects of the geometry of the mixing shaft 302, such as the length and diameter, may be varied as necessary to suit the requirements of a particular application. As disclosed elsewhere herein, the relative length of the mixing shaft 302 can be readily adjusted. Further details concerning this adjustment process are provided elsewhere herein in connection with the discussion of the transfer element 206 and associated shaft locks 304. Another useful aspect of the construction of the mixing shaft 302 is that the mixing shaft 302 is relatively flexible and not particularly susceptible to plastic deformation, as are metal or metallic mixing shafts.

With continuing attention to FIG. 4, the impeller 306 that is attached to the mixing shaft 302 may be constructed from the same, or comparable materials, used in the construction of the mixing shaft 302. The illustrated embodiment indicates only a single impeller 306, however, the scope of the invention is not so limited. Rather, some embodiments of the invention provide for multiple impellers on a single mixing shaft.

In at least some implementations, the impeller 306 and/or the mixing elements 306B are interchangeable. In this way, an operator can readily reconfigure the mixing assembly 300 to suit a particular mixing application without having to disassemble the mixer 100. In yet other implementations, the body 306A of the impeller 306 is integral with the mixing shaft 302, while the mixing elements 306B are nonetheless removably attached to the body 306A.

While the illustrated embodiment indicates a pair of mixing elements 306B included in the impeller 306, the scope of the invention is not so limited. For example, the size, number, positioning, geometry, and/or orientation of the mixing elements 306B may be selected as necessary to suit the requirements of a particular application. Thus, exemplary mixing elements 306B may flat, bent or curved, or some combination thereof. In addition, the length and/or width of one or more mixing elements 306B may be varied as desired. As well, the geometry and/or the way in which the mixing elements 306B are attached to the body 306A may be varied as necessary to provide for different “angles of attack” of the mixing elements 306B, relative to the materials that need to be mixed.

For example, a relatively low angle of attack of the mixing elements 306B relative to the mixed fluid may be desirable in cases where the mixed fluid is particularly shear sensitive. In other cases, a relatively higher angle of attack may be employed where the material to be mixed is not so shear sensitive. Because the mixing elements 306B are interchangeable in at least some implementations of the invention, the mixer 100 can be quickly and easily reconfigured for use with a wide variety of different types of materials.

It should be noted that various implementations of the mixing shaft 302 and/or impeller 306 may be employed. With attention now to FIG. 4A, details are provided concerning an exemplary alternative hollow mixing shaft/impeller 303. In the illustrated implementation, the hollow mixing shaft/impeller 303 includes one or more knockout membranes 303A that can be readily removed by a user so as to facilitate fluid sampling when a hollow shaft configuration is still immersed in a barrel of material.

Additionally, a shaft block 303B is provided, proximate mixing elements 306B attachment points 303C, that prevents contamination from passing through the hollow shaft and entering the mixed fluid. The shaft block 303B further prevents fluid and/or suspended materials from caking or accumulating on the inside of the hollow shaft.

V. Aspects of an Exemplary Transfer Element

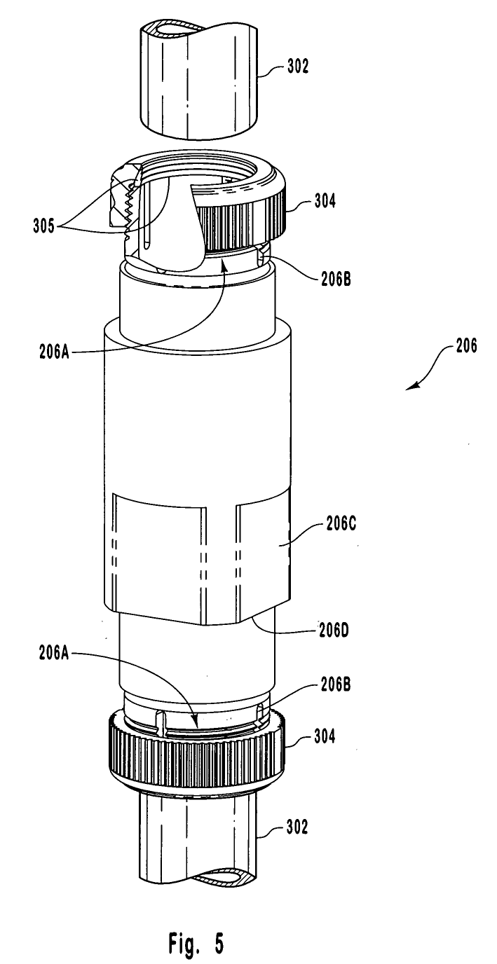

Directing attention now to FIG. 5, details are provided concerning the exemplary illustrated embodiment of the transfer element 206. As indicated, the transfer element 206 is generally cylindrical in shape and includes a threaded connection 206A at either end. Each of the threaded connections 206A defines one or more slots 206B which serve to allow the shaft locks 304 to tightly compress the threaded connections 206A, through the use of a ferrule 305, onto the mixing shaft 302. The ferrule 305 may comprise rubber, metal, plastic, or any other suitable material. In some applications, the ferrule 305 may be omitted. The transfer element 206 further includes a set of flats 206C that, as noted in connection with the discussion of FIG. 2A above, serve to help prevent relative rotation between the transfer element 206 and the output gear 404E (see FIG. 2A).

With renewed attention now to FIG. 1, and with continuing attention to FIG. 5, the transfer element 206 is configured in the illustrated embodiment to extend partially through the housing 202 of the power head 200, as best illustrated in FIG. 1. When the transfer element 206 is thus arranged and disposed, the mixing shaft 302 can then be inserted through the transfer element 206 as shown, and then secured in a desired position relative to the housing 202 by way of the shaft locks 304. Thus, the transfer element 206 serves not only to transfer power to the mixing shaft 302, but also serves to securely retain the mixing shaft 302 in a desired position and to cooperate with the shaft locks 304 to facilitate ready adjustment of the relative length of mixing shaft 302. Thus, the length of the mixing shaft 302 can be adjusted as necessary to suit the particular application in which the mixer 100 will be employed.

In this regard, it should be noted that the transfer element 206 shaft locks 304, and ferrule 305 when employed, collectively comprise one exemplary structural implementation of a means for positioning and locking the mixing shaft. However, any other structure or combination of structures effective in implementing such functionality may alternatively be employed. Accordingly, the scope of the invention should not construed to be limited solely to the disclosed embodiments.

Another exemplary structural implementation of a means for positioning and locking the mixing shaft involves the use of a single shaft lock 304, so that the positioning of the mixing shaft 302 can be achieved without necessitating removal of the mixer 100 from the barrel. Instead, with such a configuration, the cover 208 can simply be moved to the open position and the upper shaft lock 304 loosened, thereby enabling the change to the position of the mixing shaft 302. On the desired position has been achieved, the shaft lock 304 can then be retightened and operation of the mixer 100 resumed.

In addition to the flats 206C, the illustrated embodiment of the transfer element 206 further includes one or more shoulders 206D oriented so that the transfer element 206 and the mixing shaft 302 are not inadvertently pulled or drawn downward out of the power head 200. (See also, FIG. 2A.)

Exemplary implementations of the transfer element 206 are substantially composed of materials such as plastic, nylon, PTFE or PFA. However, any other suitable materials may alternatively be employed. Additionally, the illustrated embodiment of the transfer element 206 is a single piece construction. However, it may useful in some applications and implementations to construct the transfer element 206 out of multiple different components.

VI. Aspects of an Exemplary Barrel Adapter

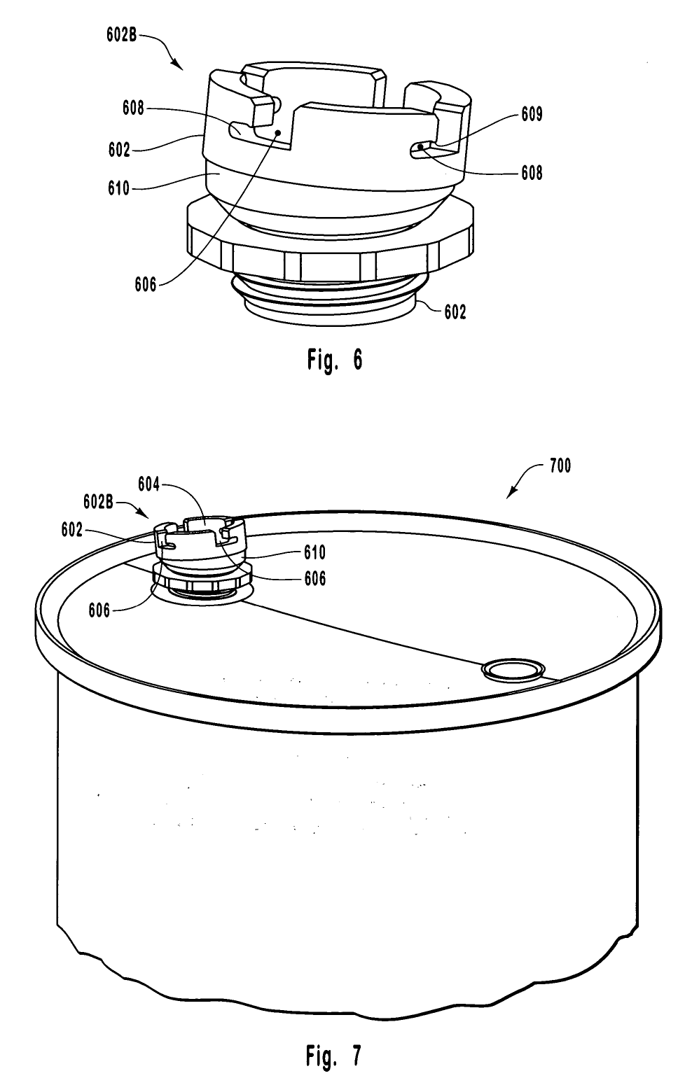

With attention now to FIG. 6, and with renewed attention to FIG. 1, details are provided concerning an exemplary embodiment of a barrel adapter, denoted generally at 600 for use in connection with mixing drums or barrels, which may be composed of a variety of materials, including plastics such as polyethylene, and metals.

In some embodiments, the barrel adapter 600 is substantially circular in shape and includes a body 602 that defines a bore 604 having a diameter sufficient to accommodate the mixing shaft 302 (FIG. 1). A lower end 602A of the body 602 is threaded or otherwise configured to releasably interface with a bung hole of one or more types of standard containers or barrels. An upper end 602B of the body 602 is configured, in this exemplary embodiment, with a number of slots 606, each of which communicates with the corresponding groove 608. In some cases, four slots 606 provide good results. More generally however, the number of slots 606 may be selected as necessary to suit the requirements of a particular application.

In general, the slots 606 and grooves 608 are configured and arranged to accommodate the projections 401A (see e.g. FIG. 1 and FIG. 2) of the motor 400 in a bayonet mount arrangement so that when the barrel adapter 600 is threaded into the bung hole of the barrel or other container, the mixer 100 can be readily mounted to the barrel adapter 600 by aligning each projection 401 with a corresponding slot 606 and then rotating the mixer 100 until the locking pins 401B engage tabs 609 of the barrel adapter. Thus, the mixer 100 requires only a few degrees of rotation to engage the locking pins 401B, which rely on spring loading and the tab 609 feature to secure the mixer 100 in place.

In at least some embodiments of the invention, the barrel adapter 600 is configured so that a quarter turn of the mixer 100 is sufficient to releasably secure the mixer 100 in position relative to the barrel adapter 600. Of course, various other arrangements may be employed and, accordingly, the scope of the invention should not be construed to be limited to the illustrated embodiment. For example, a ⅛ turn or other turns may alternatively be implemented. Once the mixer 100 is positioned thus, the mixing shaft 302 extends through the bore 604 of the barrel adapter 600 and into the barrel or other container.

As in the case of other elements of the mixer 100, the barrel adapter 600 is substantially composed, in at least some embodiments, of plastic, PTFE, PFA or other suitable material. Further, the barrel adapter 600 may be implemented as a single piece construction or, may alternatively be composed of two or more separate elements joined together.

Directing attention now to FIG. 7, and with continuing reference to FIG. 6, further details are provided concerning an exemplary embodiment of the barrel adapter 600. For example, the barrel adapter 600 is shown positioned within a barrel 700 in connection with which the mixer 100 may be employed. It was noted earlier that it is desirable in some cases to be able to insert the mixing shaft into the barrel 700 at a particular angle, such as in a non-vertical orientation. To this end, the illustrated embodiment of the barrel adapter 600 implements an angled configuration, exemplified by the wedge portion 610 of the barrel adapter 600.

In this way, the lower portion 602A of the barrel adapter 600 is positioned so as to be substantially parallel with the bung hole connection defined by barrel 700, while the upper portion 602B of the barrel adapter 600 is disposed at an angle defined by the wedge portion 610. Thus, when the mixer 100 is mounted to the barrel adapter 600, as described above, the mixing shaft 302 is disposed within the barrel 700 at a predetermined angle so as to provide desired results, such as a pump effect from the bottom to the top of the barrel, and/or a swirl effect in the mixed material. This predetermined angle can comprise any desired angle. In some cases the optimal tilt angle may be defined by the barrel geometry and/or the particular material that is to be mixed. For example, a mixing shaft angle in the range of about 5 degrees to about 10 degrees off of vertical has proven to be optimal in some applications. In some applications, a mixing shaft angle of about 7.5 degrees provides good results. The scope of the invention is not limited to any particular tilt angle or range of angles however.

As suggested by the foregoing, the desired or optimal tilt angle of the mixing shaft may vary from one application to another. Accordingly, an operator can simply change the tilt angle by replacing one barrel adapter with another barrel adapter having a different wedge angle. Thus, the mixer 100 can be readily repositioned as necessary to suit the requirements of a particular application.

Further, because the barrel adapters 600 are relatively simple in construction, it would not be cost prohibitive for an operator to purchase multiple barrel adapters, each having a different wedge angle. Further, the barrel adapters may be color coded or otherwise designated so that an operator can tell at a glance what the particular wedge angle of the barrel adapter is. Thus, use of colored or marked barrel adapters would contribute to minimization of mistakes or problems involving the use of the barrel adapter with incorrect or less than desirable wedge angle.

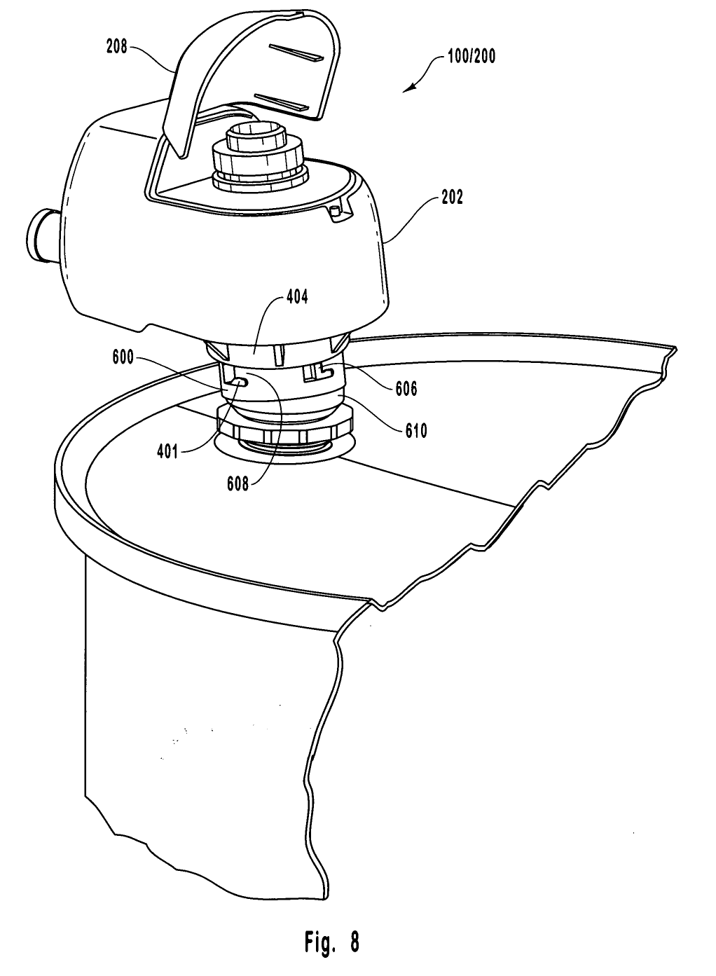

With attention now to FIG. 8, an exemplary embodiment of the mixer 100 is depicted in an operational position. In particular, the barrel adapter 600 is attached to the barrel as shown and, the projections 401 of the motor 400 are positioned within the corresponding grooves 608 defined by the barrel adapter 600. The wedge portion 610 of the barrel adapter 600 acts to position the mixing shaft (not shown) in a desired orientation. Once positioned thus, the mixer 100 is then ready for operation.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

1. A power head suitable for use in connection with a mixing shaft, the power head comprising:
a housing;
a motor substantially disposed within the housing and including an output element arranged so that power supplied to the motor causes a corresponding movement of the output element;
a gear train having an input gear and an output gear, the input gear being coupled at least indirectly with the output element of the motor;
a transfer element coupled to the output gear of the gear train and configured to interface with the mixing shaft; and
at least one shaft lock configured to cooperate with the transfer element to facilitate positioning and locking of the mixing shaft in a plurality of different operating positions.

2. The power head as recited in claim 1, wherein the motor is configured to be powered by one of: DC current; or, compressed air.

3. The power head as recited in claim 1, wherein the motor is configured with a bayonet-type mount.

4. The power head as recited in claim 1, wherein the gear train is interchangeable with at least one other gear train.

5. The power head as recited in claim 1, wherein the output gear of the gear train and the transfer element are configured and arranged such that rotation of the output gear and the transfer element, relative to each other, is substantially precluded.

6. The power head as recited in claim 1, wherein the gear train is substantially comprised of non-metallic materials.

7. The power head as recited in claim 1, wherein the gear train is configured so that when power is applied to the motor, the input gear turns at a faster RPM than the output gear.

8. The power head as recited in claim 1, wherein the output gear of the gear train defines an opening wherein the transfer element is at least partially received.

9. The power head as recited in claim 1, wherein the transfer element includes a threaded portion on at least one end, the threaded portion being configured to be removably engaged by the shaft lock.

10. The power head as recited in claim 1, wherein the transfer element has an inner diameter sufficiently large to at least partially receive the mixing shaft.

11. The power head as recited in claim 1, wherein the transfer element defines a flat that cooperates with the output gear of the gear train so that rotation of the output gear and the transfer element, relative to each other, is substantially precluded when the transfer element is coupled to the output gear.

12. The power head as recited in claim 1, wherein the transfer element substantially comprises a non-metallic material.

13. The power head as recited in claim 1, wherein the shaft lock comprises:
a compression nut configured to engage a threaded portion of the transfer element; and
a ferrule disposed within the compression nut and configured to contact the mixing shaft.

14. The power head as recited in claim 1, further comprising a valve configured and arranged to facilitate control of a flow of compressed air to the motor.

15. The power head as recited in claim 1, wherein the gear train further comprises an intermediate gear positioned to be driven by the input gear and to drive the output gear.

16. The power head as recited in claim 1, wherein the housing further comprises a movable cover configured and arranged to allow positioning and repositioning of the mixing shaft when the mixing shaft is received in the power head.

17. A mixing assembly suitable for use in connection with a power head, the mixing assembly comprising:
a mixing shaft having first and second ends, the first end being configured to attach at least indirectly to the power head, and the mixing shaft being substantially non-metallic; and
an impeller attached to the second end of the mixing shaft, the impeller being substantially non-metallic and comprising:
a body; and
at least one mixing element attached to the body.

18. The mixing assembly as recited in claim 17, wherein at least one of the mixing shaft and the impeller substantially comprises plastic.

19. The mixing assembly as recited in claim 17, wherein the plastic substantially comprises one of: PFA; polypropylene; or, polyethylene

20. The mixing assembly as recited in claim 17, wherein the impeller is removably attached to the mixing shaft.

21. The mixing assembly as recited in claim 17, wherein the body of the impeller is integral with the mixing shaft.

22. The mixing assembly as recited in claim 17, wherein at least one mixing element is rotatably attached to the body.

23. The mixing assembly as recited in claim 17, wherein the at least one mixing element comprises two or more mixing elements.

24. The mixing assembly as recited in claim 17, wherein the at least one mixing element is configured to assume a desired angle of attack with respect to a fluid, in which the mixing element is at least partially immersed, when the mixing shaft rotates at a predetermined RPM.

25. The mixing assembly as recited in claim 17, wherein the mixing shaft is configured to assume a plurality of different operating positions, relative to the power head.

26. The mixing assembly as recited in claim 17, further comprising at least one additional impeller, the at least one additional impeller being attached to the mixing shaft.

27. A mixer for use in connection with materials processing, the mixer comprising:
a mixing assembly, the mixing assembly comprising:
a mixing shaft that is substantially non-metallic; and
an impeller attached to an end of the mixing shaft, the impeller being substantially non-metallic and comprising:
a body; and
at least one mixing element attached to the body; and
a power head configured to attach to the mixing assembly, the power head comprising:
a housing;
a motor substantially enclosed by the housing and having an output element arranged so that power supplied to the motor connection causes movement of the output element;
a reduction gear train having an input and an output, the input being coupled at least indirectly with the output element of the motor; and
means for positioning and locking the mixing shaft, the means for positioning and locking the mixing shaft facilitating positioning and locking of the mixing shaft in a plurality of operating positions, and the means for positioning and locking the mixing shaft interfacing with the reduction gear train to facilitate rotation of the mixing shaft.

28. The mixer as recited in claim 27, wherein the at least one mixing element is configured to assume a desired angle of attack with respect to a fluid, in which the mixing element is at least partially immersed, when the mixing shaft rotates at a predetermined RPM.

29. The mixer as recited in claim 27, wherein the at least one mixing element is rotatably attached to the body.

30. The mixer as recited in claim 27, wherein the at least one mixing element comprises two or more mixing elements.

31. The mixer as recited in claim 27, wherein at least one of the mixing shaft and the impeller substantially comprises PFA.

32. The mixer as recited in claim 27, wherein the motor is configured to be powered by compressed air.

33. The mixer as recited in claim 27, wherein the motor is configured with a bayonet-type mount.

34. The mixer as recited in claim 27, wherein the reduction gear train is interchangeable with at least one other gear train.

35. The mixer as recited in claim 27, wherein the means for positioning and locking the mixing shaft comprises:
a transfer element coupled to the output of the reduction gear train and configured to removably receive at least a portion of the mixing shaft, and the transfer element including first and second threaded portions through which the mixing shaft passes;
first and second compression nuts configured to releasably engage, respectively, the first and second threaded portions of the transfer element; and
a ferrule disposed within each of the first and second compression nuts.

36. The mixer as recited in claim 27, further comprising a speed monitoring system comprising:
a speed sensor configured for operable communication with a rotating element of the mixing assembly; and
a display configured for communication with the speed sensor.

37. The mixer as recited in claim 27, further comprising a closed loop speed monitoring and control system comprising:
a speed sensor configured for operable communication with a rotating element of the mixing assembly;
a display configured for communication with the speed sensor;
an error detector comprising:
a measured speed signal input in communication with the speed sensor;
a reference speed signal input; and
a corrected speed output; and
a controller configured to communicate with the corrected speed output of the error detector, the controller also being in communication with the motor.

38. The mixer as recited in claim 27, further comprising an open loop speed monitoring and control system comprising:
a speed sensor configured for operable communication with a rotating element of the mixing assembly;
a display configured for communication with the speed sensor; and
a controller configured to receive a reference speed input signal, and the controller being in communication with the motor.

39. The mixer as recited in claim 27, further comprising a barrel adapter comprising:
an upper portion configured to engage the motor in a releasable bayonet-type attachment;
a lower portion attached at least indirectly to the upper portion and including a set of threads configured to releasably mate with a fluid container; and
a wedge portion attached to the upper and lower portions and having an associated wedge angle such that at least part of the upper portion is non-parallel with respect to at least part of the lower portion, the wedge portion cooperating with the upper and lower portions to define a bore configured to receive the mixing shaft.

40. The mixer as recited in claim 27, wherein the barrel adapter is coded with a color corresponding to the wedge angle.

41. The mixer as recited in claim 27, wherein the barrel adapter substantially comprises plastic.
